(19) United States
(12) Patent Application Publication
(10) Pub. No.: US 2023/0226549 A1
(43) Pub. Date: Jul. 20, 2023

(54) Modular Active Surface Devices for Microfluidic Systems and Methods of Making Same Including Adhesive-Free Assembly

(71) Applicant: Redbud Labs, Inc., Research Triangle Park, NC (US)

(72) Inventors: Richard Spero, Research Triangle Park, NC (US); Jay Fisher, Research Triangle Park, NC (US); Brittany Mason, Research Triangle Park, NC (US)

(73) Assignee: Redbud Labs, Inc., Research Triangle Park, NC (US)

(21) Appl. No.: 18/023,123

(22) PCT Filed: Aug. 24, 2021
(86) PCT No.: PCT/US2021/047269

§ 371 Date: Feb. 24, 2023

Related U.S. Application Data
(60) Provisional application No. 63/070,526, filed on Aug. 26, 2020.

(51) Int. Cl. B01L 3/00

(52) U.S. Cl. CPC B01L 3/502746; B01L 3/502707; B01L 3/527; B01L 2200/16; B01L 2200/028; B01L 2400/084; B01L 2300/0887

(57) ABSTRACT

Modular active surface devices for microfluidic systems and methods of making the same including adhesive-free assembly are disclosed. In some embodiments, the presently disclosed modular active surface devices and methods provide adhesive-free assembly processes, such as, but not limited to, laser beam welding (LBW) processes, ultrasonic welding processes, heat welding processes, chemical bonding processes, mechanical compression processes, and the like. In some embodiments, the modular active surface devices and methods provide a reagent hopper or well that is out-of-plane with the reaction chamber.

### RELATED APPLICATIONS

The presently disclosed subject matter claims priority and is related to U.S. Provisional Patent Application No. 63/070,526, entitled “Modular Active Surface Devices for Microfluidic Systems and Methods of Making Same Including Adhesive-Free Assembly,” filed on Aug. 26, 2020, and is also related to the U.S. Patent Application Publication No. 2020/0254454, entitled “Modular Active Surface Devices for Microfluidic Systems and Methods of Making Same,” published on Aug. 13, 2020; the entire disclosure of which is incorporated herein by reference.

### TECHNICAL FIELD OF THE INVENTION

The presently disclosed subject matter relates generally to the processing of biological materials and more particularly to modular active surface devices for microfluidic systems and methods of making the same including adhesive-free assembly.

### BACKGROUND

Microfluidic systems can include an active surface, which can be, for example, any surface or area (typically inside a reaction or assay chamber) that is used for processing biological materials. However, there can be considerable cost and complexity associated with providing an active surface within microfluidic systems. Further, there can be certain barriers to testing the active surface performance within the microfluidic system. Therefore, new approaches are needed to simplify the process of providing an active surface in a microfluidic system.

### SUMMARY OF THE INVENTION

The present invention provides a modular active surface device. In one embodiment, the modular active surface device may include the following layers: a bottom substrate that may include an active surface layer; a mask layer on the active surface that may include an internal opening establishing a reaction chamber; a top substrate on the mask layer that may enclose the reaction chamber, wherein the top substrate may include a reagent hopper enclosed therein. In another embodiment, the modular active surface device may include a first port in the top substrate to provide a fluid path from the reagent hopper into the reaction chamber. In another embodiment, the modular active surface device may include a second port in the bottom substrate, the mask layer, or the top substrate to provide a fluid path out of the reaction chamber. In yet another embodiment, the top substrate may include a mask layer enclosing the reaction chamber and the first port in the top substrate may provide a fluid path from the top substrate into the reaction chamber, i.e., no reagent hoppers are included.

In another embodiment, the top substrate on the mask layer may include two or more reagent hoppers oriented out-of-plane of the reaction chamber.

In still another embodiment, one or more reagent hoppers each may hold a quantity of a dried reagent.

In another embodiment, the dried reagent may be selected from a group consisting of a pellet, a cake, a block, a brick, a sphere, or dried beads of a dried reagent.

In still another embodiment, the one or more reagent hoppers may each hold a quantity of a rehydrated dried reagent.

In yet other embodiments, each reagent hopper may contain a reagent selected from a group consisting of a rehydratable dried reagent, a liquid reagent, or a releasable reagent.

In still other embodiments, the reagent hoppers each may contain the same reagent or a different reagent.

In another embodiment, the active surface layer may include actuatable microposts attached to the surface of the active surface layer, wherein the actuatable microposts may extend into the reaction chamber.

In certain embodiments, the actuatable microposts attached to the surface of the active surface layer may be configured for actuation in the presence of an actuation force.

In other embodiments, the actuation force may be selected from a group consisting of a magnetic field, a thermal field, a sonic field, an optical field, an electrical field, and a vibrational field.

In other embodiments, the active surface layer in the reaction chamber may be configured for mixing operations, binding operations, and cell processing operations.

In another embodiment, the modular active surface device may further include: an active surface substrate that includes: an actuatable micropost active surface layer and a continuous pointed ridge feature displaced around the perimeter of a reaction chamber, wherein the pointed ridge feature may protrude from an upper surface of the active surface substrate and toward the actuatable micropost active surface layer; an opposing V-shaped groove feature may be provided on an inner surface of a microfluidics cartridge substrate, wherein the location, size, and shape of the opposing V-shaped groove feature may substantially correspond to the location, size, and shape of the pointed ridge feature; and a means for applying a compression force; wherein the means for applying a compression force may be arranged relative to the pointed ridge feature such that application of a compression force may cause the pointed ridge feature to engagedly fit into the opposing V-shaped groove feature of the microfluidics cartridge substrate, thereby forming a seal.

In yet another embodiment, the modular active surface device may include a chamber that may include a bottom substrate including an active surface; a mask layer on the active surface that may include an internal opening establishing a reaction chamber, wherein the active surface may be exposed to the reaction chamber opening; a top substrate on the mask layer that may enclose the reaction chamber, wherein the top layer may include a reagent hopper enclosed therein; and a fluid passage from the reagent hopper to the reaction chamber opening.

The present invention provides a system. In one embodiment, the system may include a modular active surface device, wherein the modular active surface device may be engagedly coupled to an instrument that may include a magnetic apparatus configured to impart movement to the active surface. In another embodiment, the active surface may include a plurality of surface-attached structures attached to the inside or inner surface at a plurality of respective attachment sites and extending into the interior therefrom, wherein the surface-attached structures each may include a flexible body and a metallic component disposed on or in the body.

The present invention provides a microfluidics cartridge. In one embodiment, the microfluidics cartridge may include a substrate that may include a recessed region for receiving a modular active surface device, wherein the modular active surface device may be sized to engagedly fit into a corresponding recessed region of the microfluidics cartridge, and wherein fluid ports of the modular active surface device may be fluidly connected to fluid lines of the microfluidics cartridge. In another embodiment, the microfluidics cartridge substrate may be substantially non-reactive to laser energy and the modular active surface device substrate may be substantially reactive to laser energy. In yet another embodiment, the microfluidics cartridge substrate may be substantially reactive to laser energy and the modular active surface device substrate may be substantially non-reactive to laser energy.

In yet another embodiment, the modular active surface device may include an integrated clamping feature or mechanism, wherein the integrated clamping feature or mechanism may be arranged relative to the constituent layers of the modular active surface device such that compressing the integrated clamping feature or mechanism may create a compression force that may hold the constituent layers of the modular active surface device together.

In still another embodiment, the integrated clamping mechanism may include one or more clearance regions each possessing an opening at or near the center of the clearance region; and a pointed feature protruding from the active surface substrate and pointing towards the one or more openings, wherein the pointed feature may be substantially aligned with the one or more openings through which the pointed feature may pass and wherein the opening may be sized to receive the pointed feature. In yet another embodiment, the sharpness of the pointed feature may be suitable to push through the active surface layer without a pre-existing opening to accommodate pointed features passing therethrough. In yet another embodiment, the active surface layer may include pre-existing openings to accommodate pointed features passing therethrough. In still another embodiment, the modular active surface device may further include a mask layer that may possess an opening through which the pointed feature may pass.

The present invention provides a process of forming a modular active surface device. In one embodiment, the method may include the following steps: (a) providing (i) an active surface substrate with an active surface layer and (ii) an inner surface of a microfluidics cartridge substrate of the present invention that includes an integrated clamping mechanism according to the present invention; (b) bringing together the active surface substrate with the active surface layer with the microfluidics cartridge substrate such that the pointed features of the active surface substrate may substantially align with the openings in the microfluidics cartridge substrate; (c) applying an external compression force to the active surface substrate with the active surface layer and the microfluidics cartridge substrate such that tips of the pointed features of the active surface substrate may push through openings in the microfluidics cartridge substrate; (d) while maintaining the compression force and with the tips of the pointed features of the active surface substrate exposed within the clearance regions of the microfluidics cartridge substrate, applying heat energy to the tips of the pointed features, wherein the heat energy may cause the tips to melt and thereby form a rivet-head type feature; and (e) ceasing the application of the heat energy and removing the external compression force, wherein the formed rivet-head type feature may provide a clamping force against the microfluidics cartridge substrate.

In another embodiment, heat energy may be applied at the location of each integrated clamping mechanism.

In certain embodiments, heat energy may be applied by a heated mandrel or plate.

The present invention provides a process for forming a modular active surface device. In one embodiment, the process may include the following steps: (a) providing microposts of the micropost active surface layer of the present invention that may include magnetically responsive elements; (b) providing the micropost substrate of the micropost active surface layer of the present invention that may include embedded acrylic microspheres; (c) providing the active surface substrate, the mask layer, and, in certain other embodiments, the microfluidics cartridge substrate of the present invention, wherein the active surface substrate, the mask layer, and the microfluidics cartridge substrate may include an acrylic compatible thermoplastic; (d) applying bonding energy to create bonding interfaces, wherein the bonding interfaces may weld the micropost active surface to both the active surface substrate and the mask layer and bond the mask layer to the microfluidics cartridge substrate, wherein the bonding energy may melt the acrylic microspheres embedded in the micropost substrate thereby creating welding joints at the bonding interfaces.

In another one embodiment, the bonding energy may be provided by an ultrasonic welding process.

In yet another embodiment, the bonding energy may be provided by a laser beam welding (LBW) process.

In still another embodiment, the bonding energy may be provided by a heating process.

The present invention provides a process for forming a modular active surface device.

In one embodiment, the process may include the following steps: (a) providing microposts of the micropost active surface layer comprising magnetically responsive elements; (b) providing the micropost substrate of the micropost active surface layer comprising polydimethylsiloxane (PDMS); (c) providing the active surface substrate, the mask layer, and microfluidics cartridge substrate, wherein the active surface substrate, the mask layer, and the microfluidics cartridge substrate comprise a thermoplastic material; (d) treating the surface of the micropost substrate of the micropost active surface layer with an amine group generator to create a type A chemical treatment layer; (e) treating the surface of the active surface substrate with an epoxy group generator to create a type B chemical treatment layer; (f) bringing together the type A chemical treatment layer and the type B chemical treatment layer to initiate the formation of a chemical bond between a lower surface of the micropost substrate and an upper surface of the active surface substrate, respectively, wherein the micropost substrate of the micropost active surface layer may be thereby chemically bonded to the active surface substrate.

In another embodiment, the amine group generator may be (3-Aminopropyl) triethoxysilane (APTES).

In another embodiment, the epoxy group generator may be selected from a group consisting of silane coatings, 3-(glycidoxypropyl) triethoxysilane (GOPTES), or glues.

In yet another embodiment, the chemical treatments may be formed in a liquid phase or a vapor phase.

In still another embodiment, the process may further include masking the reaction chamber of the upper surface of the micropost substrate of the micropost active surface layer during the APTES treatment process to selectively form the type A chemical treatment layer, wherein the masking may reduce interference with processes occurring in the reaction chamber.

The present invention provides a modular active surface device. In one embodiment, the modular active surface device may include: (a) an active surface substrate that may include an actuatable micropost active surface layer and a continuous pointed ridge feature displaced around the perimeter of a reaction chamber, wherein the pointed ridge feature may protrude from an upper surface of the active surface substrate and toward the actuatable micropost active surface layer; (b) an opposing V-shaped groove feature may be provided on an inner surface of a microfluidics cartridge substrate, wherein the location, size, and shape of the opposing V-shaped groove feature may substantially correspond to the location, size, and shape of the pointed ridge feature; and a means for applying a compression force, wherein the means for applying a compression force may be arranged relative to the pointed ridge feature of the active surface substrate such that when a compression force is applied to the pointed ridge feature of the active surface substrate it may engagedly fit into the V-shaped groove feature of the microfluidics cartridge substrate, thereby forming a seal.

In another embodiment, the compression force may be applied via an arrangement of the integrated clamping mechanisms of the present invention.

The present invention provides a process for producing modular active surface devices. In one embodiment, the process may include the steps of: (a) providing a laminate sheet that may include multiple modular active surface devices according to the present invention, wherein the laminate sheet may possess an equal corresponding number of standard patterns of preformed integrated clamping mechanisms according to the present invention, wherein each standard pattern of preformed clamping mechanisms may contain a modular active surface device at or near a center point bounded by the pattern of preformed clamping mechanisms; (b) forming a plurality of through-holes or perforation lines in the laminate sheet to form a separable active surface wafer; and (c) separating the separable active surface wafer into multiple individual modular active surface devices, wherein each modular active surface device may be bounded by a pattern of preformed clamping mechanisms. In another embodiment, step (c) may include a cutting process. In yet another embodiment, the laminate sheet may be composed of polydimethylsiloxane (PDMS).

The present invention provides modular active surface devices that may be made or manufactured using the processes of the present invention.

### BRIEF DESCRIPTION OF THE DRAWINGS

The accompanying drawings, which are incorporated in and constitute a part of this specification, illustrate certain embodiments, and together with the written description, explain certain principles of the methods, devices, and systems disclosed herein. The drawings are included by way of example and not by way of limitation. Like reference numerals identify like components throughout the drawings unless the context indicates otherwise. Some or all of the figures may be schematic representations.

FIG. 1 illustrates a top view and a side view of an example of a modular active surface device including a reagent hopper or well;

FIG. 2 illustrates a top view and a side view of an example of a process of forming the modular active surface device including the reagent hopper shown in FIG. 1;

FIG. 3 illustrates a top view and a side view of another example of a modular active surface device including a reagent hopper or well;

FIG. 4 illustrates a top view and a side view of an example of a process of forming the modular active surface device including the reagent hopper shown in FIG. 3;

FIG. 5A and FIG. 5B illustrate side views of an example of microposts of the presently disclosed modular active surface devices;

FIG. 6A and FIG. 6B illustrate side views of a micropost and show examples of the actuation motion thereof;

FIG. 7A and FIG. 7B illustrate side views of an example of a process of using laser beam welding for installing modular active surface devices in a fluidics cartridge, which is one example of an adhesive-free assembly process;

FIG. 8A and FIG. 8B illustrate side views of an example of a process of using laser beam welding for installing modular active surface devices in a fluidics cartridge, which is another example of an adhesive-free assembly process;

FIG. 9 illustrates a top view and a side view of an example of a modular active surface device including integrated clamp mechanisms for compressing and holding together the structure thereof, which is another example of an adhesive-free assembly process;

FIG. 10 and FIG. 11 illustrate top views of examples of large-scale manufacturing processes that may utilize an arrangement of the integrated clamp mechanisms shown in FIG. 9 for forming modular active surface devices;

FIG. 12 illustrates a side view of an example of another welding process for forming modular active surface devices, which is yet another example of an adhesive-free assembly process for forming modular active surface devices;

FIG. 13, FIG. 14, and FIG. 15 illustrate side views of examples of utilizing chemical bonding processes for forming modular active surface devices, which is still another example of an adhesive-free assembly process for forming modular active surface devices; and

FIG. 16 illustrates a top view and a side view of an example of a modular active surface device including an adhesive-free chamber sealing process.

### GENERAL DEFINITIONS

“Active surface” means any surface or area that can be used for processing samples. The active surface can be inside a reaction or assay chamber. For example, the active surface can be any surface that has properties designed to manipulate the fluid inside the chamber.

“Sample” means a source of cells for culturing. Examples include biological materials, fluids, environmental samples (e.g., water samples, air samples, soil samples, solid and liquid wastes, and animal and vegetable tissues), and industrial samples (e.g., food, reagents, and the like).

“Manipulation” means causing a physical change in a cell sample. Examples include generating fluid flow, altering the flow profile of an externally driven fluid, fractionating the sample into constituent parts, establishing or eliminating concentration gradients within the chamber, and the like. Examples of surface properties useful for manipulation include post technology—whether static or actuated (i.e., activated). The surface properties may also include microscale texture or topography in the surface, physical perturbation of the surface by vibration or deformation; electrical, electronic, electromagnetic, and/or magnetic system on or in the surface; optically active (e.g., lenses) surfaces, such as embedded light-emitting diodes (LEDs) or materials that interact with external light sources; and the like.

“Surface-attached post” or “surface-attached micropost” or “surface-attached structure” or “micropost” are used interchangeably. Generally, a surface-attached structure has two opposing ends: a fixed end and a free end. The fixed end may be attached to a substrate by any suitable means, depending on the fabrication technique and materials employed. The fixed end may be “attached” by being integrally formed with or adjoined to the substrate, such as by a microfabrication process. Alternatively, the fixed end may be “attached” via a bonding, adhesion, fusion, or welding process. The surface-attached structure has a length defined from the fixed end to the free end, and a cross-section lying in a plane orthogonal to the length. For example, using the Cartesian coordinate system as a frame of reference, and associating the length of the surface-attached structure with the z-axis (which may be a curved axis), the cross-section of the surface-attached structure lies in the x-y plane.

The cross-section of the surface-attached structure may have any shape, such as rounded (e.g., circular, elliptical, etc.), polygonal (or prismatic, rectilinear, etc.), polygonal with rounded features (e.g., rectilinear with rounded corners), or irregular. The cross-section may be symmetrical or asymmetrical. The size of the cross-section of the surface-attached structure in the x-y plane may be defined by the “characteristic dimension” of the cross-section, which is shape-dependent. As examples, the characteristic dimension may be diameter in the case of a circular cross-section, major axis in the case of an elliptical cross-section, or maximum length or width in the case of a polygonal cross-section. The characteristic dimension of an irregularly shaped cross-section may be taken to be the dimension characteristic of a regularly shaped cross-section that the irregularly shaped cross-section most closely approximates (e.g., diameter of a circle, major axis of an ellipse, length or width of a polygon, etc.).

A surface-attached structure as described herein may be non-movable (static, rigid, etc.) or movable (flexible, deflectable, bendable, etc.) relative to its fixed end or point of attachment to the substrate. To facilitate the movability of movable surface-attached structures, the surface-attached structure may include a flexible body composed of an elastomeric (flexible) material and may have an elongated geometry in the sense that the dominant dimension of the surface-attached structure is its length; that is, the length is substantially greater than the characteristic dimension. Examples of the composition of the flexible body include, but are not limited to, elastomeric materials such as hydrogel and other active surface materials (for example, polydimethylsiloxane (PDMS)).

The movable surface-attached structure is configured such that the movement of the surface-attached structure relative to its fixed end may be actuated or induced in a non-contacting manner by an actuation force. For example, to render the surface-attached structure movable by an applied magnetic or electric field, the surface-attached structure may include an appropriate metallic component disposed on or in the flexible body of the surface-attached structure. To render the surface-attached structure responsive to a magnetic field, the metallic component may be a ferromagnetic material such as, for example, iron, nickel, cobalt, or magnetic alloys thereof, one non-limiting example being “alnico” (an iron alloy containing aluminum, nickel, and cobalt). To render the surface-attached structure responsive to an electric field, the metallic component may be a metal exhibiting electrical conductivity such as, for example, copper, aluminum, gold, and silver, and various other metals and metal alloys. Depending on the fabrication technique utilized, the metallic component may be formed as a layer (or coating, film, etc.) on the outside surface of the flexible body at a selected region of the flexible body along its length. The layer may be a continuous layer or a densely grouped arrangement of particles. Alternatively, the metallic component may be formed as an arrangement of particles embedded in the flexible body at a selected region thereof.

“Actuation force” means the force applied to the microposts. For example, the actuation force may include a magnetic, thermal, sonic, or electric force. Notably, the actuation force may be applied as a function of frequency or amplitude, or as an impulse force (i.e., a step function). Similarly, other actuation forces may be used without departing from the scope of the present subject matter, such as fluid flow across the micropost array (e.g., flexible microposts that are used as flow sensors via monitoring their tilt angle with an optical system). In one example, the actuation force is an applied magnetic or electric field of a desired strength, field line orientation, and frequency (which may be zero in the case of a magnetostatic or electrostatic field).

Application of an actuation force actuates the movable surface-attached microposts into movement. For example, the actuation may occur by contacting a cell processing chamber with a control instrument comprising elements that provide an actuation force, such as a magnetic or electric field. Accordingly, the control instrument includes, for example, any mechanisms for actuating the microposts (e.g., magnetic system), any mechanisms for counting the cells (e.g., imaging system), the pneumatics for pumping the fluids (e.g., pumps, fluid ports, valves), and a controller (e.g., microprocessor).

“Flow cell” is any chamber comprising a solid surface across which one or more liquids can be flowed, wherein the chamber has at least one inlet and at least one outlet.

“Micropost array” is an array of small posts, extending outwards from a substrate, that typically range from 1 to 100 micrometers in height. In one embodiment, microposts of a micropost array may be vertically aligned. Notably, each micropost includes a proximal end that is attached to the substrate base and a distal end or tip that is opposite the proximal end. Microposts may be arranged in arrays such as, for example, the microposts described in U.S. Pat. No. 9,238,869, entitled “Methods and systems for using actuated surface-attached posts for assessing biofluid rheology,” issued on Jan. 19, 2016; the entire disclosure of which is incorporated herein by reference. U.S. Pat. No. 9,238,869 describes methods, systems, and computer readable media for using actuated surface-attached posts for assessing biofluid rheology. One method described in U.S. Pat. No. 9,238,869 is directed to testing properties of a biofluid specimen that includes placing the specimen onto a micropost array having a plurality of microposts extending outwards from a substrate, wherein each micropost includes a proximal end attached to the substrate and a distal end opposite the proximal end, and generating an actuation force in proximity to the micropost array to actuate the microposts, thereby compelling at least some of the microposts to exhibit motion. This method further includes measuring the motion of at least one of the microposts in response to the actuation force and determining a property of the specimen based on the measured motion of the at least one micropost.

U.S. Pat. No. 9,238,869 also states that the microposts and micropost substrate of the micropost array can be formed of polydimethylsiloxane (PDMS). Further, microposts may include a flexible body and a metallic component disposed on or in the body, wherein application of a magnetic or electric field actuates the microposts into movement relative to the surface to which they are attached (e.g., wherein the actuation force generated by the actuation mechanism is a magnetic and/or electrical actuation force).

“Magnetically responsive” means responsive to a magnetic field. “Magnetically responsive microposts” include or are composed of magnetically responsive materials. Examples of magnetically responsive materials include, but are not limited to, paramagnetic materials, ferromagnetic materials, ferrimagnetic materials, and metamagnetic materials. Examples of suitable paramagnetic materials include iron, nickel, and cobalt, as well as metal oxides, such as, but not limited to, ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP).

“Micropost field” or “micropost array” means a field or an array of small posts, extending outwards from a substrate. The posts typically range from about 1 to about 100 micrometers in height.

The terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact but may be approximate and/or larger or smaller as desired, reflecting tolerances, conversion factors, rounding off, measurement error and the like, and other factors known to those of skill in the art depending on the desired properties sought to be obtained by the invention. Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

### Modular Active Surface Devices for Microfluidic Systems and Methods of Making Same Including Adhesive-Free Assembly

In some embodiments, the presently disclosed subject matter provides modular active surface devices for microfluidic systems and methods of making the same including adhesive-free assembly.

In some embodiments, the presently disclosed modular active surface devices for microfluidic systems and methods provide adhesive-free assembly processes, such as, but not limited to, laser beam welding (LBW) processes, ultrasonic welding processes, heat welding processes, chemical bonding processes, mechanical compression processes, and the like.

In some embodiments, the presently disclosed modular active surface devices for microfluidic systems and methods provide a hopper or well for holding dried reagent that may be rehydrated and then the liquid reagent supplied to the reaction chamber of the modular active surface devices and wherein the hopper or well may be provided out-of-plane with the reaction chamber.

In some embodiments, the presently disclosed modular active surface devices for microfluidic systems and methods provide a process of using laser beam welding (LBW) process for bonding a modular active surface device to a fluidics cartridge, which is one example of an adhesive-free assembly process.

In some embodiments, the presently disclosed modular active surface devices for microfluidic systems and methods provide an arrangement of integrated clamp mechanisms formed via a heat welding process for mechanically compressing and holding together the modular active surface device structure, which is another example of an adhesive-free assembly process.

In some embodiments, the presently disclosed modular active surface devices for microfluidic systems and methods provide a welding process that may include acrylic microspheres embedded in a PDMS layer of, for example, a micropost active surface layer and wherein the acrylic microspheres enable welding to other thermoplastic layers in the modular active surface device structure, which is another example of an adhesive-free assembly process.

In some embodiments, the presently disclosed modular active surface devices for microfluidic systems and methods provide surface-attached microposts on a microposts substrate and wherein the surface-attached microposts are loaded one way (e.g., loaded with magnetically responsive elements) while the micropost substrate is loaded another way (e.g., loaded with acrylic microspheres).

In some embodiments, the presently disclosed modular active surface devices for microfluidic systems and methods provide chemical bonding processes for forming modular active surface devices, which is another example of an adhesive-free assembly process.

In some embodiments, the presently disclosed modular active surface devices for microfluidic systems and methods provide an (3-Aminopropyl) triethoxysilane (APTES) treatment process of the PDMS material and thermoplastic layers treated with epoxy groups and wherein the APTES can be used to generate amine groups on the PDMS that can be used to covalently bond to the epoxy groups on thermoplastics.

In some embodiments, the presently disclosed modular active surface devices for microfluidic systems and methods provide an adhesive-free sealing process of the reaction chamber, such as, but not limited to, a substantially continuous pointed ridge feature in one substrate and an opposing v-groove feature in an opposing substrate and with a micropost active surface layer sandwiched therebetween.

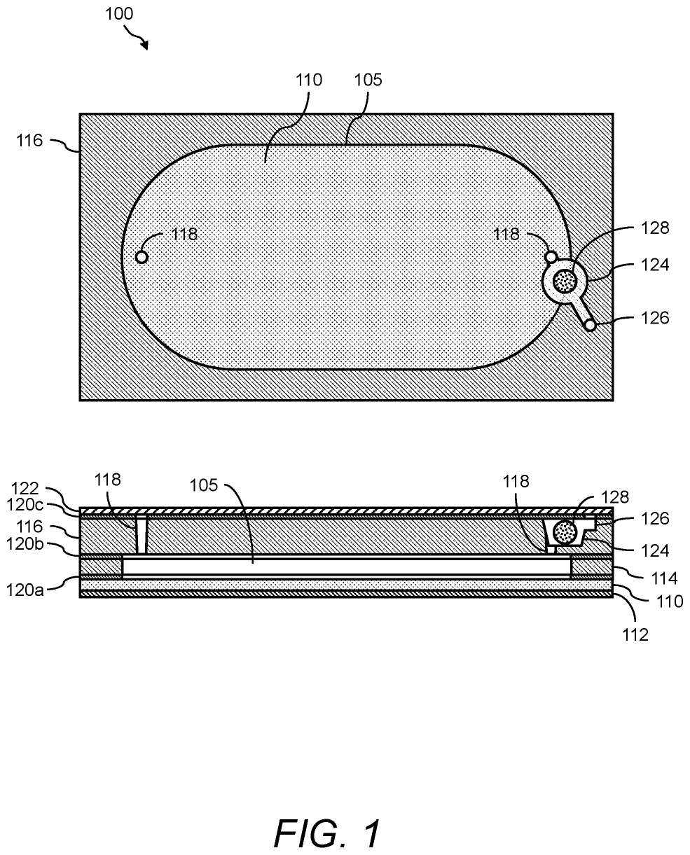

Referring now to FIG. 1 is a top view and a side view of an example of a modular active surface device 100 including a reagent hopper or well. In this example, the reagent hopper or well may be located out-of-plane (e.g., above the plane) of the reaction chamber of modular active surface device 100. Any dried reagent held in the out-of-plane reagent hopper or well may be rehydrated. Then the liquid reagent in the reagent hopper or well may be supplied to the reaction chamber of modular active surface device 100.

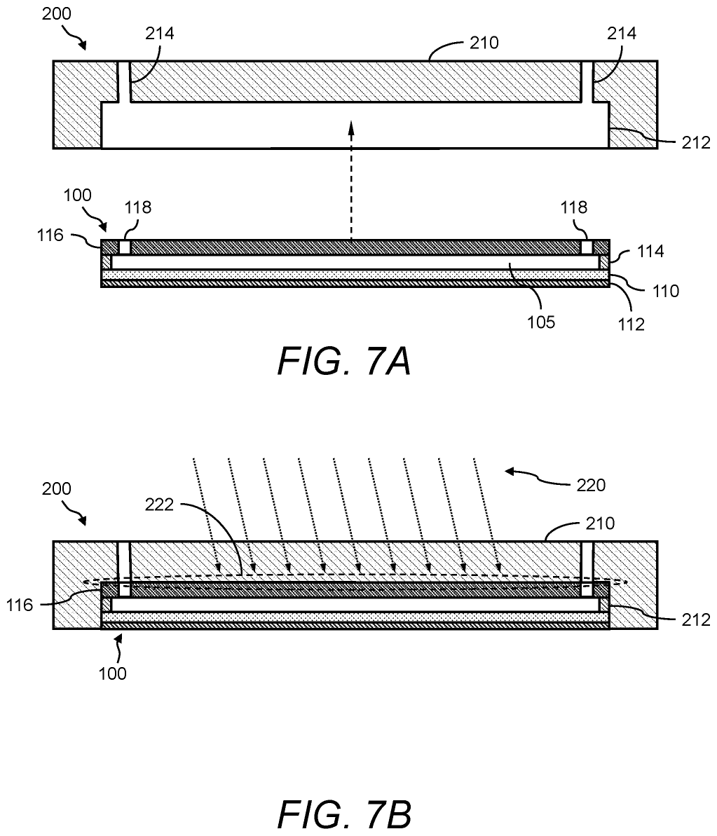

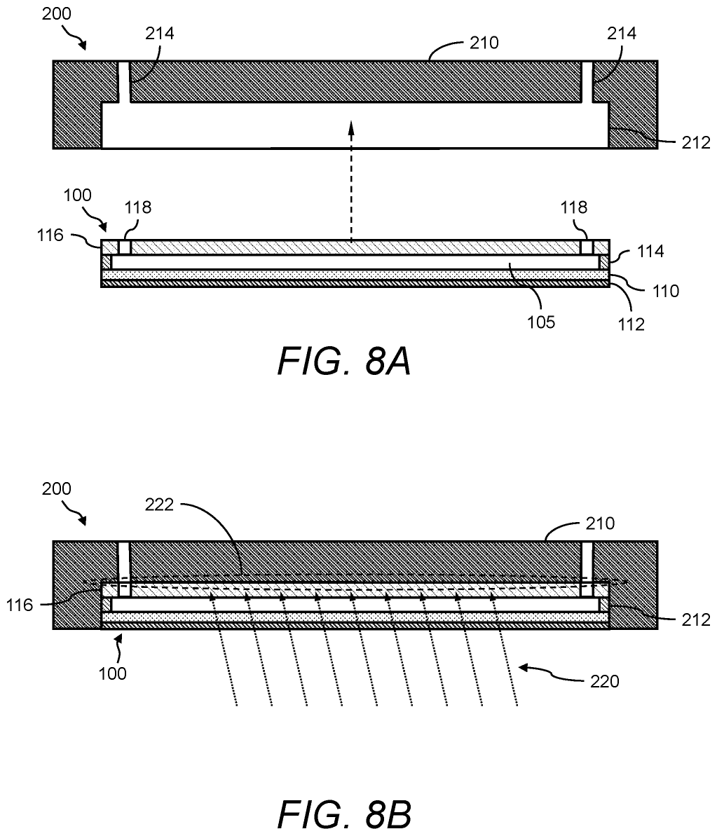

In this example, modular active surface device 100 provides a structure that includes a reaction chamber 105 that includes at least one active surface layer 110. Active surface layer 110 may be mounted atop an active surface substrate 112. Additionally, modular active surface device 100 includes a mask layer 114 mounted atop active surface layer 110 wherein mask layer 114 defines the area, height, and volume of reaction chamber 105, and a substrate 116 mounted atop mask layer 114. Further, modular active surface device 100 includes fluid ports 118 (e.g., an input port and output port) in relation to reaction chamber 105. In this example, modular active surface device 100 provides a simple flow cell device. Further, in this example, modular active surface device 100 may be designed to drop-into a corresponding fluidics cartridge, such as the fluidics cartridge shown in FIG. 7A, FIG. 7B, FIG. 8A, and FIG. 8B.

In modular active surface device 100, mask layer 114 defines the area, height, and volume of reaction chamber 105. In reaction chamber 105, substrate 116 provides the facing surface to active surface layer 110. In other examples, instead of substrate 116 facing the active surface layer 110, modular active surface device 100 can include two active surface layers 110 that face each other in reaction chamber 105.

In this example, the structure of modular active surface device 100 may include one or more adhesive layers 120. In one example, adhesive layers 120 may be ARcare 90445, which has clear peelable liners. Adhesive layers 120 may be “pressure sensitive” adhesives, meaning they require pressure only (no solvents, heat, UV, etc.) to make the bond. For example, an adhesive layer 120a may be used to bond together active surface layer 110 and mask layer 114. An adhesive layer 120b may be used to bond together mask layer 114 and substrate 116. Further, an adhesive layer 120c may be provided atop substrate 116. Adhesive layer 120c provides a sealed cover to modular active surface device 100 until ready for use. Further, adhesive layer 120c provides a mechanism for bonding modular active surface device 100 into a corresponding fluidics cartridge. A protective layer 122, which may be a peel-off protective liner, is provided atop adhesive layer 120c.

Further, modular active surface device 100 may include a reagent hopper (or well) 124 integrated into substrate 116. Reagent hopper 124 has an inlet 126. Further, an outlet of reagent hopper 124 supplies one of the fluid ports 118 of reaction chamber 105. Reagent hopper 124 may be used to hold a quantity of dried reagent 128. Dried reagent 128 may be, for example, a pellet, cake, block, brick, or sphere of any dried reagent material (e.g., formed by either lyophilization or evaporation). Optionally, dried reagent 128 may include beads.

In this example, reagent hopper 124 is located out-of-plane (e.g., above the plane) of reaction chamber 105. At run time, dried reagent 128 in the out-of-plane reagent hopper 124 may be rehydrated. Then the liquid reagent in reagent hopper 124 may be supplied to reaction chamber 105 of modular active surface device 100.

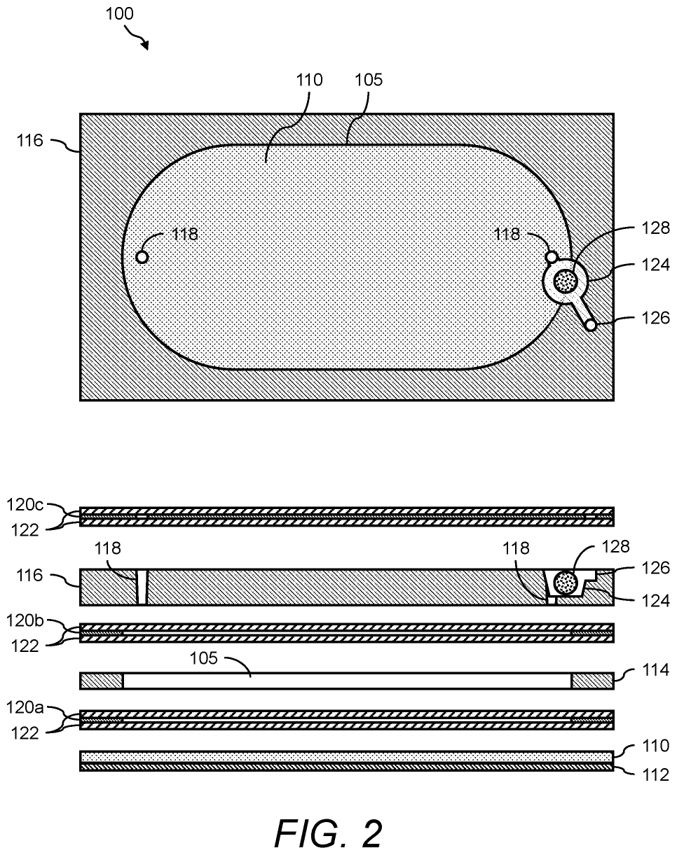

Referring now to FIG. 2 is a top view and a side view of an example of a process of forming modular active surface device 100 shown in FIG. 1 that includes reagent hopper 124.

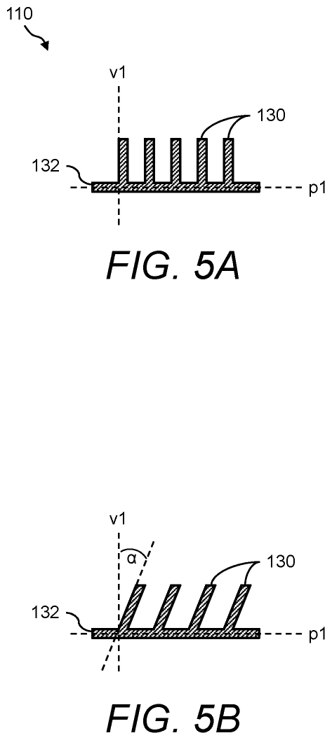

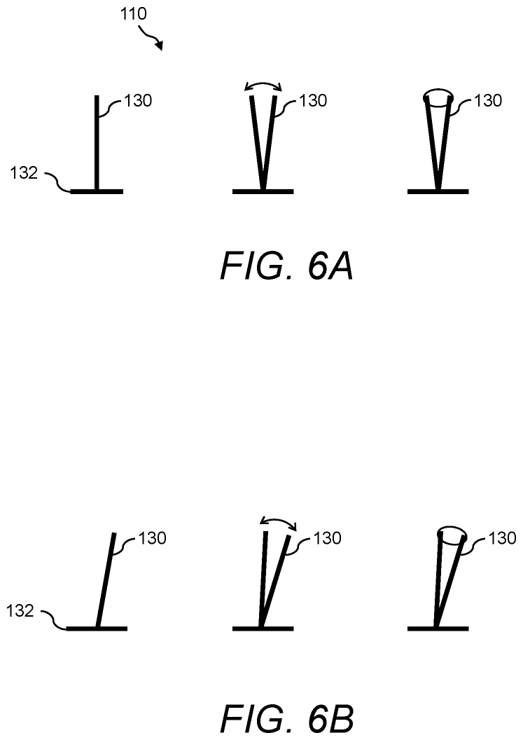

For example, in a first step, active surface layer 110 mounted atop active surface substrate 112 is provided. In one example, active surface layer 110 may be a micropost active surface layer 110 formed, for example, of polydimethylsiloxane (PDMS), as described hereinbelow with reference to FIG. 5A, FIG. 5B, FIG. 6A, and FIG. 6B. Namely, microposts (not visible in FIG. 1 and FIG. 2) of micropost active surface layer 110 are extending into reaction chamber 105.

Active surface substrate 112 is the backing layer for, for example, the micropost active surface layer 110. Active surface substrate 112 may be a rigid or semi-rigid substrate formed, for example, of glass, plastic, silicon, or silicone. In one example, active surface substrate 112 is a plastic substrate, such as a substrate formed of the semi-rigid Melinex® brand polyester film available from DuPont Teijin Films (Chester, Va.). The thickness of the Melinex® active surface substrate 112 can be from about 100 μm to about 500 μm in one example or is about 250 μm in another example. Some determining characteristics of active surface substrate 112 may include, for example, optical transparency, thickness, rigidity, flexibility, whether passive or active (e.g., electrodes, magnets, LEDs, micropost actuation mechanisms, micropost motion detection mechanisms, etc.), and/or function. Function may be, for example, magnetic applications, optical sensor applications, and/or illumination applications.

In another step, adhesive layer 120a with its two protective layers 122 intact may be provided. An opening in adhesive layer 120a substantially corresponds to the footprint of reaction chamber 105 in mask layer 114. Then, the lower protective layer 122 may be peeled away and adhesive layer 120a may be affixed to the upper surface of, for example, the micropost active surface layer 110.

In another step, mask layer 114 may be provided. Mask layer 114 may be, for example, a plastic, glass, or silicon mask. The thickness of mask layer 114 may be from about 50 μm to about 1,000 μm in one example or is about 150 μm in another example. Openings in mask layer 114 may define certain features of modular active surface devices 100, such as the area, height, and volume of reaction chamber 105.

In another step, the upper protective layer 122 of adhesive layer 120a may be peeled away. Then, using adhesive layer 120a, the lower surface of mask layer 114 may be bonded to, for example, the micropost active surface layer 110.

In another step, adhesive layer 120b with its two protective layers 122 intact may be provided. An opening in adhesive layer 120b substantially corresponds to the footprint of reaction chamber 105 in mask layer 114. Then, the lower protective layer 122 may be peeled away and adhesive layer 120b may be affixed to the upper surface of mask layer 114.

In another step, substrate 116 may be provided. Substrate 116 may be, for example, a plastic, glass, or silicon substrate. Substrate 116 may have any thickness suitable to define any features therein, such as the area, height, and volume of reagent hopper 124 and such as the features of fluid ports 118.

In another step, the upper protective layer 122 of adhesive layer 120b may be peeled away. Then, using adhesive layer 120b, the lower surface of substrate 116 may be bonded to the upper surface of mask layer 114.

In another step, a certain quantity of dried reagent 128 may be placed into reagent hopper 124 of substrate 116. For example, a specified volume of dried reagent 128 as needed for running a certain assay or reaction in modular active surface device 100 is placed into reagent hopper 124 of substrate 116.

In another step, adhesive layer 120c with its two protective layers 122 intact may be provided. Then, the lower protective layer 122 may be peeled away and adhesive layer 120c may be affixed to the upper surface of substrate 116. Further, the upper protective layer 122 of adhesive layer 120c may be left intact. Accordingly, adhesive layer 120c with its upper protective layer 122 still intact serves as a “sealed cover” for modular active surface device 100 (see FIG. 1) as it awaits installation into a corresponding fluidics cartridge. Accordingly, adhesive layer 120c may be used for bonding modular active surface device 100 into the corresponding fluidics cartridge.

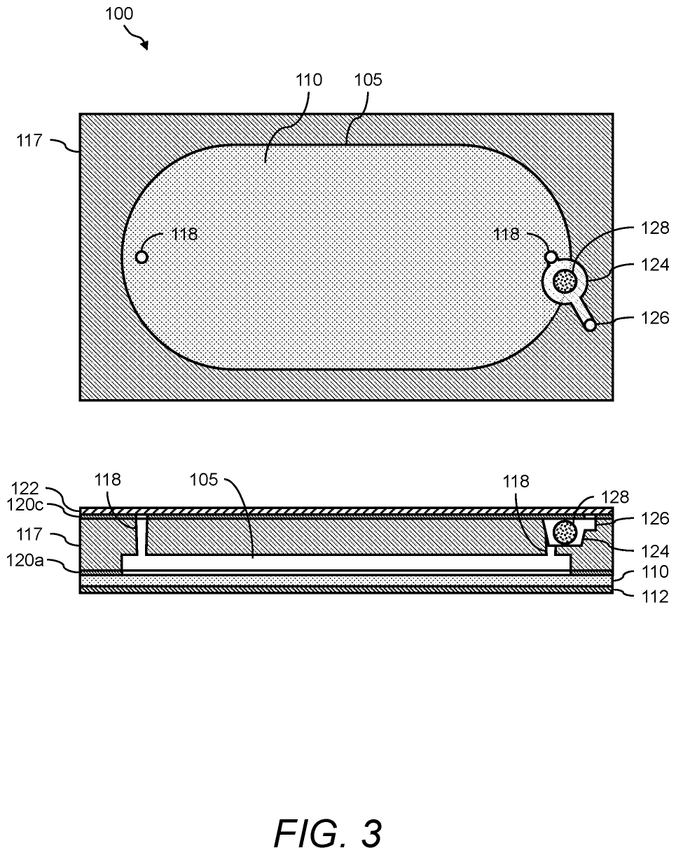

Referring now to FIG. 3 is a top view and a side view of another example of a modular active surface device 100 including a reagent hopper or well, such as reagent hopper 124. Modular active surface device 100 shown in FIG. 3 is substantially the same as modular active surface device 100 shown in FIG. 1 except that the arrangement of mask layer 114, adhesive layer 120b, and substrate 116 is replaced with a substrate 117. Substrate 117 may be, for example, a thermoplastic substrate formed by an injection molding process. In one example, substrate 117 is formed of polyethylene terephthalate (PET). Substrate 117 includes reaction chamber 105, fluid ports 118 supplying reaction chamber 105, and reagent hopper 124 in a space and in a plane above reaction chamber 105. The overall geometry and features of substrate 117 may substantially correspond to the overall geometry and features of the arrangement of mask layer 114, adhesive layer 120b, and substrate 116 shown in FIG. 1.

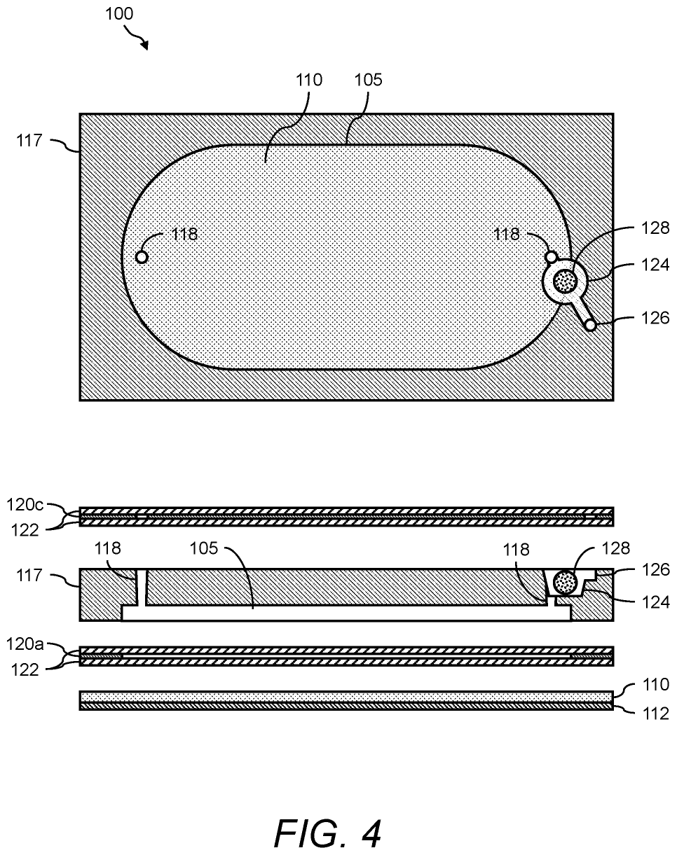

Referring now to FIG. 4 is a top view and a side view of an example of a process of forming modular active surface device 100 shown in FIG. 3 that includes reagent hopper 124. The process of forming modular active surface device 100 shown in FIG. 3 substantially corresponds to the process described in FIG. 2 except that substrate 117 is provided, which replaces mask layer 114, adhesive layer 120b, and substrate 116.

Referring now again to FIG. 1, FIG. 2, FIG. 3, and FIG. 4, at run time, dried reagent 128 in the out-of-plane reagent hopper 124 may be rehydrated. Then the liquid reagent in reagent hopper 124 may be supplied to reaction chamber 105 of modular active surface device 100. The geometry of reagent hopper 124 may include features to, for example, avoid any dried reagent material blocking the flow. Further, the pellet, cake, block, brick, or sphere of dried reagent 128 and the outlet or drain of reagent hopper 124 may be shaped and/or spaced in such a way as to avoid dried reagent 128 from blocking the outlet. That is, the combined geometry of reagent hopper 124 and dried reagent 128 is provided in a way to substantially ensure no initial blockage and no blockage during flow while dried reagent 128 is dissolving.

However, in another example, it may be desirable that dried reagent 128 be mostly dissolved before flowing into reaction chamber 105. In this example, the combined geometry of reagent hopper 124 and dried reagent 128 is provided in a way to substantially ensure that the outlet or drain of reagent hopper 124 is blocked until dried reagent 128 is substantially dissolved. Then, a sudden release of liquid reagent occurs from reagent hopper 124 into reaction chamber 105.

Further, there may be a desired relation between the volume of reagent hopper 124 and the volume of reaction chamber 105. Generally, the volume of fluid needed to rehydrate a dried reagent may be at least equal to the volume of the dried reagent 128 itself. Further, the volume of reagent hopper 124 may be less than the volume of reaction chamber 105, as it may be assumed that the volume of reagent hopper 124 cannot exceed the volume of reaction chamber 105.

Modular active surface device 100 is not limited to one reagent hopper 124 only. In other embodiments, modular active surface device 100 may include multiple reagent hoppers 124 holding dried reagent 128. In one example, modular active surface device 100 may include multiple independently controlled reagent hoppers 124 and feeding reaction chamber 105. In another example, modular active surface device 100 may include multiple reagent hoppers 124 arranged in series and feeding reaction chamber 105. In yet another example, modular active surface device 100 may include multiple reagent hoppers 124 arranged in parallel and feeding reaction chamber 105. In still another example, modular active surface device 100 may include any combinations of multiple independently controlled reagent hoppers 124, multiple reagent hoppers 124 arranged in series, and multiple reagent hoppers 124 arranged in parallel. Further, any arrangement of multiple reagent hoppers 124 in modular active surface device 100 may operate in such a way as to deploy reagents separately or together.

The reaction chamber of the modular active surface device may be loaded with one or more reagents via the reagent hoppers, e.g., a rehydrated (rehydratable) dried reagent, a liquid reagent, or a “delayed release” or “releasable” reagent or any combination of such reagents contained in separate reagent hoppers. As a non-limiting example, if one reagent needs to be resuspended or otherwise made ready for use prior to the use of another reagent or after the use of another reagent, then a “releasable” reagent may be encapsulated in a reagent material that undergoes a phase transition, such as a wax (releasable by an increase in temperature) or a soluble “crust” (releasable by an extended exposure to solvent), for release at the desired time of use.

Additionally, and referring still to FIG. 1, FIG. 2, FIG. 3, and FIG. 4, when in use, modular active surface device 100 may have any orientation depending on the end user's system. Namely, modular active surface device 100 can be oriented substrate 116/117-side up or active surface substrate 112-side up.

FIG. 5A, FIG. 5B, FIG. 6A, and FIG. 6B show more details of an example of a “micropost” active surface layer 110 of modular active surface device 100. For example, and referring now to FIG. 5A and FIG. 5B, micropost active surface layer 110 may include a plurality of microposts 130 arranged in a micropost field or array on a micropost substrate 132. In one embodiment, microposts 130 of a micropost field or array are substantially vertical along a line v1 relative to a plane p1 established by micropost substrate 132. Notably, each micropost 130 includes a proximal end that is attached to micropost substrate 132 and a distal end or tip that is opposite the proximal end. In one example, microposts 130 may be magnetically responsive surface-attached microposts. Accordingly, at least one surface of reaction chamber 105 may include an arrangement of microposts 130 on micropost substrate 132.

Microposts 130 and micropost substrate 132 can be formed, for example, of PDMS. The length, diameter, geometry, orientation, and pitch of microposts 130 in the field or array can vary. For example, the length of microposts 130 can vary from about 1 μm to about 100 μm. The diameter of microposts 130 can vary from about 0.1 μm to about 10 μm. Further, the cross-sectional shape of microposts 130 can vary. For example, the cross-sectional shape of microposts 130 can be circular, ovular, square, rectangular, triangular, and so on. The orientation of microposts 130 can vary. For example, FIG. 5A shows microposts 130 having an axis along line v1 that is oriented substantially normal to the plane p1 of micropost substrate 132, while FIG. 5B shows microposts 130 oriented at a tilt angle α with respect to normal of the plane p1 of micropost substrate 132. In a neutral position with no actuation force applied, the tilt angle α can be, for example, from about 0 degrees to about 45 degrees. Additionally, the pitch of microposts 130 within a micropost field or array can vary, for example, from about 0 μm to about 50 μm. Further, the relative positions of microposts 130 within the micropost field or array can vary, and the microposts can have a regular or irregular pitch. Where the pitch of microposts 130 within a micropost field or array is irregular, the pitch within the irregular array can vary for example, from about 0 μm to about 50 μm.

Referring now to FIG. 6A and FIG. 6B is side views of a micropost 130 and show examples of the actuation motion thereof. For example, FIG. 6A shows an example of a micropost 130 oriented substantially normal to the plane of micropost substrate 132 (see FIG. 5A). FIG. 6A shows that the distal end of the micropost 130 can move (1) with side-to-side 2D motion only with respect to the fixed proximal end or (2) with circular (or conical) motion with respect to the fixed proximal end, which is a cone-shaped motion. By contrast, FIG. 6B shows an example of a micropost 130 oriented at an angle with respect to the plane of micropost substrate 132 (see FIG. 5B). FIG. 6B shows that the distal end of the micropost 130 can move (1) with tilted side-to-side 2D motion only with respect to the fixed proximal end or (2) with tilted circular motion with respect to the fixed proximal end, which is a tilted cone-shaped motion (or tilted conical motion).

In any of the presently disclosed modular active surface devices 100 and methods including micropost active surface layer 110, by actuating microposts 130 and causing motion thereof, any fluid in a chamber is in effect stirred or caused to flow or circulate within the chamber and across the surface area thereof. Further, the cone-shaped motion of micropost 130 shown in FIG. 6A, as well as the tilted cone-shaped motion of micropost 130 shown in FIG. 6B, can be achieved using a rotating magnetic field. A rotating magnetic field is one example of an actuation force of, for example, a magnetic actuation mechanism (not shown). Further, a magnetic actuation mechanism may be configured to actuate the magnetically responsive surface-attached microposts 130 in certain beat patterns, such as synchronized beat patterns and/or metachronal beat patterns.

Referring still to FIG. 1 through FIG. 6B, microposts 130 may be based on, for example, the microposts described in the '869 patent as described hereinabove. In one example, according to the '869 patent, microposts 130 and micropost substrate 132 can be formed of PDMS. Further, microposts 130 may include a flexible body and a metallic component disposed on or in the body, wherein application of a magnetic or electric field actuates microposts 130 into movement relative to the surface to which they are attached. Again, in the presently disclosed modular active surface devices and methods including flexible membranes and/or magnetically responsive elements, an actuation force generated by a magnetic actuation mechanism may be a magnetic actuation force. Accordingly, the magnetically responsive surface-attached microposts 130 are positioned within the magnetic actuation force generated by the magnetic actuation mechanism (not shown).

While FIG. 1, FIG. 2, FIG. 3, and FIG. 4 describe assembly processes of modular active surface devices 100 and/or microfluidics cartridges that include adhesives, in other embodiments, adhesive-free assembly is possible. For example, more details of adhesive-free assembly of modular active surface devices and/or microfluidics cartridges are shown and described hereinbelow with reference to FIG. 7A through FIG. 15.

Referring now to FIG. 7A and FIG. 7B are side views of an example of a process of using laser beam welding (LBW) for installing modular active surface devices 100 in a microfluidics cartridge, which is one example of an adhesive-free assembly process. For example, an LBW process is provided for bonding a modular active surface device 100 into a microfluidics cartridge 200.

In this example, microfluidics cartridge 200 may include a body or substrate 210 that has a recessed region 212 for receiving modular active surface device 100. For example, modular active surface device 100 is sized to be fitted into recessed region 212 of microfluidics cartridge 200. Further, the positions of fluid ports 118 of modular active surface device 100 are set to correspond to fluid lines 214 in microfluidics cartridge 200. In this way, modular active surface device 100 may be fluidly coupled to microfluidics cartridge 200.

In this example, body or substrate 210 of microfluidics cartridge 200 may be, for example, a thermoplastic material that is substantially transparent to laser energy. By contrast, substrate 116 of modular active surface device 100 may be, for example, a thermoplastic material that is black or at least opaque for absorbing laser energy. For example, FIG. 7B shows modular active surface devices 100 fitted into recessed region 212 of microfluidics cartridge 200. In this way, the upper surface of substrate 116 of modular active surface device 100 is fitted against and touching the inner surface of substrate 210 of microfluidics cartridge 200. Then, laser energy 220 is directed through substrate 210 of microfluidics cartridge 200 toward an interface region 222 of modular active surface device 100 and microfluidics cartridge 200. In this process, concentrated heat occurs at interface region 222, allowing a weld to occur between modular active surface device 100 and microfluidics cartridge 200 at interface region 222.

FIG. 8A and FIG. 8B shows substantially the same LBW process shown in FIG. 7A and FIG. 7B except that substrate 210 of microfluidics cartridge 200 may be black or at least opaque for absorbing laser energy and substrate 116 of modular active surface device 100 may be substantially transparent to laser energy. In this example, laser energy 220 is directed through substrate 116 of modular active surface device 100 toward the interface region 222 of modular active surface device 100 and microfluidics cartridge 200. Again, concentrated heat occurs at interface region 222, allowing a weld to occur between modular active surface device 100 and microfluidics cartridge 200 at interface region 222.

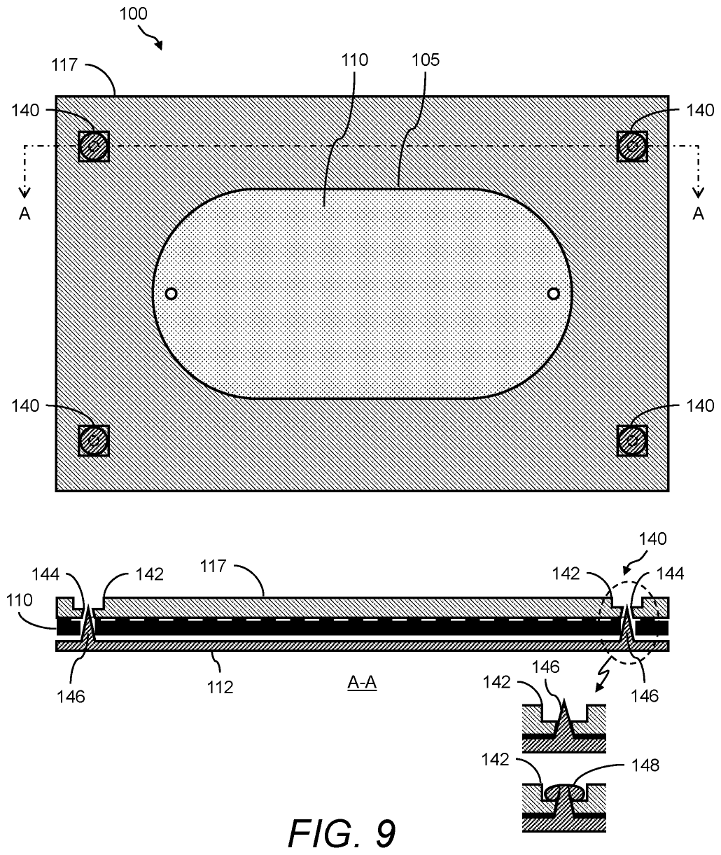

Referring now to FIG. 9 is a top view and a side view of an example of a modular active surface device 100 including integrated clamp mechanisms for compressing and holding together the structure thereof, which is another example of an adhesive-free assembly process.

For example, an arrangement of integrated clamp mechanisms 140 are provided with respect to reaction chamber 105 of modular active surface device 100. The purpose of integrated clamp mechanisms 140 is to mechanically hold a certain compression force on, for example, the stack of active surface substrate 112 supporting active surface layer 110 and substrate 117. In another example, mask layer 114 (not shown) may also be present in the stack forming modular active surface device 100.

Each integrated clamp mechanism 140 may include certain features in both active surface substrate 112 and substrate 117. For example, each integrated clamp mechanism 140 includes a clearance region 142 in substrate 117 and an opening 144 (i.e., a through-hole) in substrate 117 at about the center of clearance region 142. Additionally, each integrated clamp mechanism 140 includes a pointed (or cone-shaped) feature 146 protruding from active surface substrate 112 and toward substrate 117. Further, pointed feature 146 of active surface substrate 112 substantially aligns with opening 144 in substrate 117 and wherein opening 144 is sized to receive pointed feature 146. In the case of mask layer 114 (not shown) being present, mask layer 114 also includes an opening through which pointed feature 146 may pass. Further, the sharpness of pointed feature 146 may be suitable to push through active surface layer 110 (i.e., formed of PDMS) without a preexisting through-hole or opening. However, in another example, active surface layer 110 may include through-holes or openings to accommodate pointed features 146 passing through.

A process of forming modular active surface device 100 shown in FIG. 9 that uses an arrangement of integrated clamp mechanisms 140 may be as follows. This process may be referred to as a heat welding process.

For example, in a first step, active surface substrate 112, active surface layer 110, and substrate 117 are provided that include the features of integrated clamp mechanisms 140.

In another step, active surface substrate 112 with active surface layer 110 is brought together with substrate 117 such that pointed features 146 of active surface substrate 112 substantially align with openings 144 in substrate 117.

In another step, an external compression force is applied to active surface substrate 112 with active surface layer 110 and substrate 117 such that the tips of pointed features 146 of active surface substrate 112 push through openings 144 in substrate 117.

In another step, while continuing to hold the external compression force and with the tips of pointed features 146 of active surface substrate 112 exposed within clearance regions 142 of substrate 117, heat is applied such that each of the tips of pointed features 146 melts and forms a rivet-head type feature 148. Each of the rivet-head type features 148 provides a clamping force against substrate 117 that holds the compression force to the structure after the heating process is completed and the external compression force is removed. In this step, heating may be applied at the location of each integrated clamp mechanism 140 via, for example, a heated mandrel or heated plate. FIG. 9 shows a detailed drawing of an example of integrated clamp mechanism 140 before and after heating.

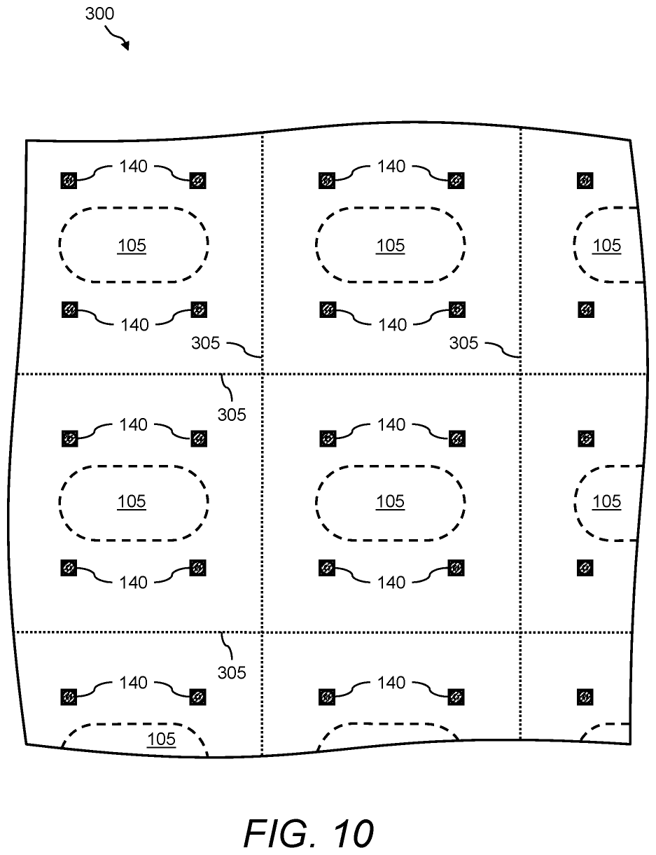

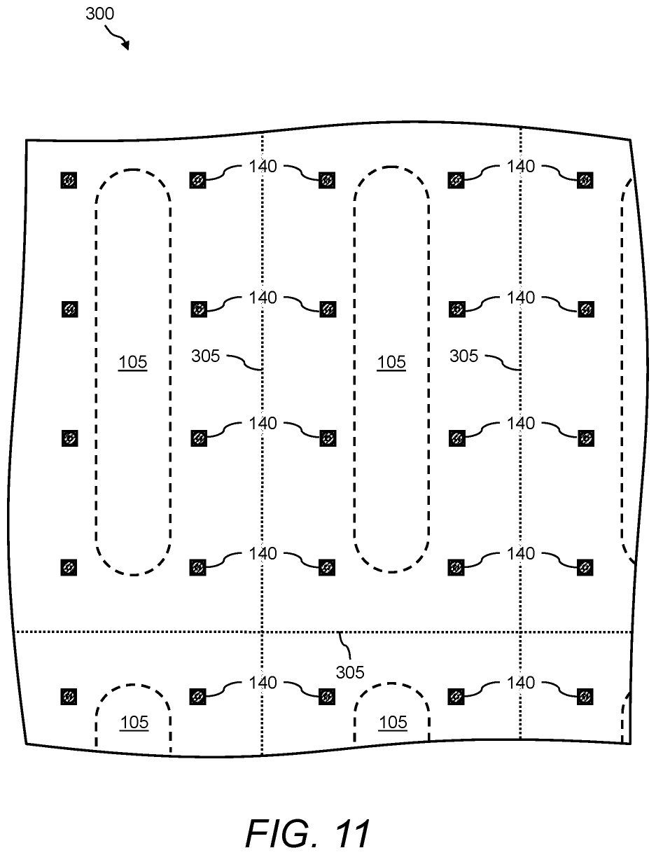

Referring now to FIG. 10 and FIG. 11, which show top views of examples of large-scale manufacturing processes that may utilize an arrangement of the integrated clamp mechanisms 140 shown in FIG. 9 for forming modular active surface devices 100. In a large-scale manufacturing process, for example, the various laminates 300 may be provided with a standard footprint or pattern of integrated clamp mechanisms 140. Then, any design of modular active surface devices 100 are laid out amongst this standard pattern. FIG. 10 shows one example of a custom layout of modular active surface devices 100 (indicated by reaction chambers 105) amongst a standard pattern of integrated clamp mechanisms 140. FIG. 11 shows another example of a custom layout of modular active surface devices 100 (indicated by reaction chambers 105) amongst a standard pattern of integrated clamp mechanisms 140. Using a standard pattern of integrated clamp mechanisms 140 allows the heating mechanism to remain unchanged from one device design to another.

FIG. 10 and FIG. 11 also show an example of perforation lines 305 for dicing or separating the individual modular active surface devices 100 once formed. In another example, the large-scale manufacturing process may include customized patterns of integrated clamp mechanisms 140 that correspond to the various designs of modular active surface devices 100.

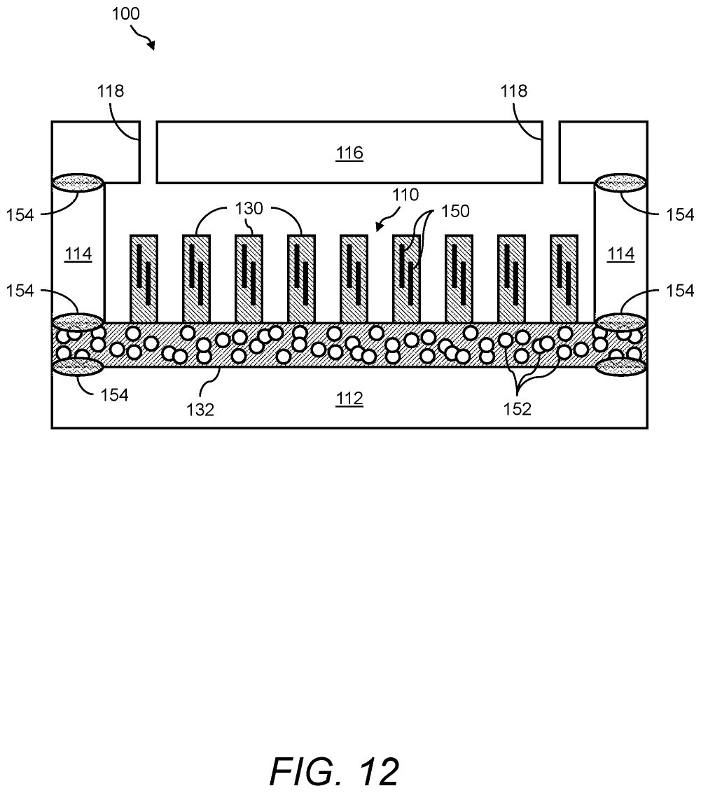

Referring now to FIG. 12 is a side view of an example of another welding process for forming modular active surface devices 100, which is yet another example of an adhesive-free assembly process. In this example, microposts 130 (e.g., PDMS microposts) of micropost active surface layer 110 may include certain magnetically responsive elements, such as, but not limited to, magnetic nanorods 150. Further, micropost substrate 132 (e.g., PDMS substrate) of micropost active surface layer 110 may include embedded acrylic microspheres 152. Further, in this example, active surface substrate 112, mask layer 114, and substrate 116 may be formed of an acrylic-compatible thermoplastic. Then, an ultrasonic welding process or LBW process may be used to bond micropost substrate 132 of micropost active surface layer 110 to both active surface substrate 112 and mask layer 114 and to also bond mask layer 114 to substrate 116. FIG. 12 shows weld joints 154 at these interfaces. The presence of the acrylic microspheres 152 in micropost substrate 132 is what enables the welding process with respect to micropost active surface layer 110. In the case of an LBW process, certain laminates in the structure may be black.

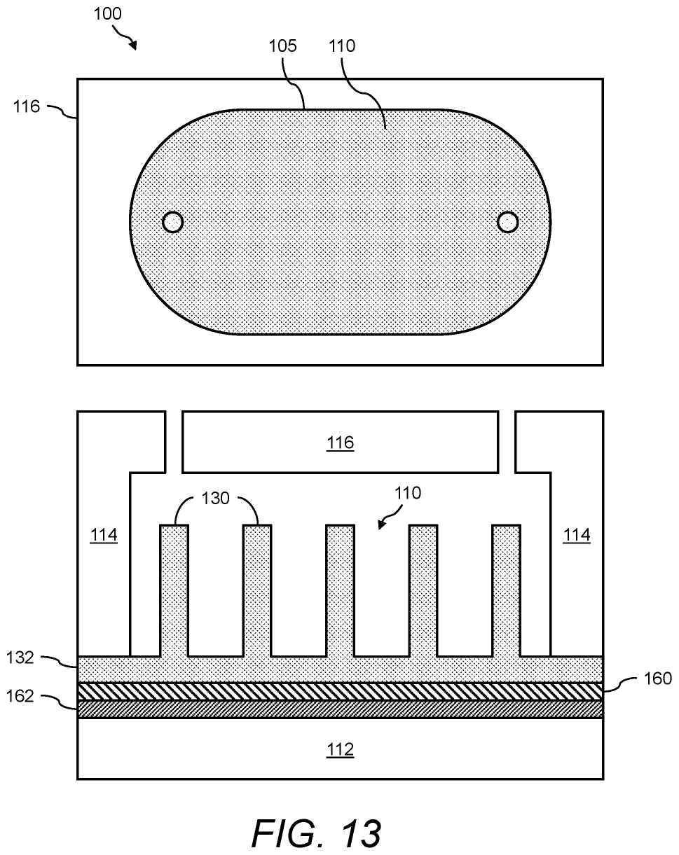

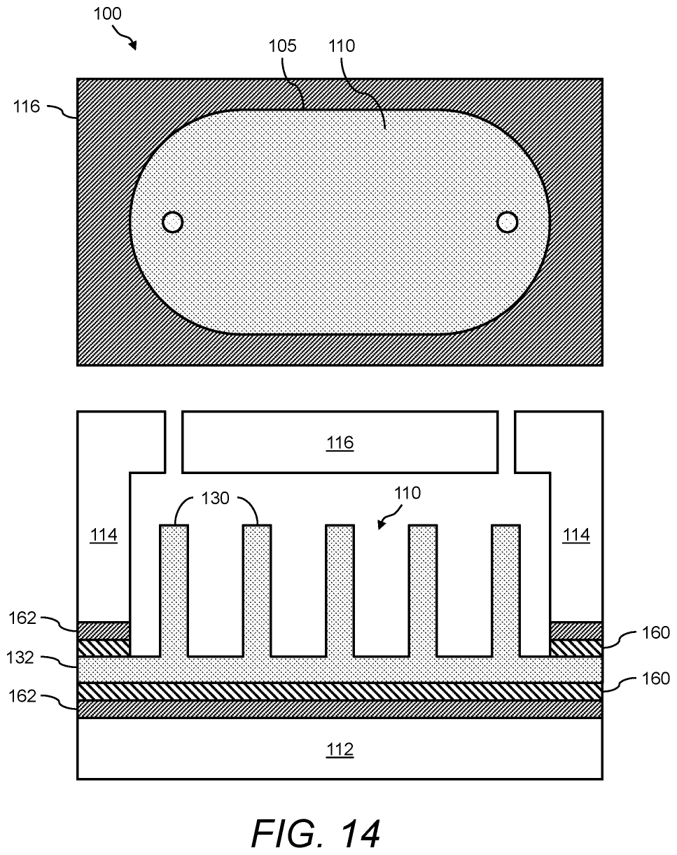

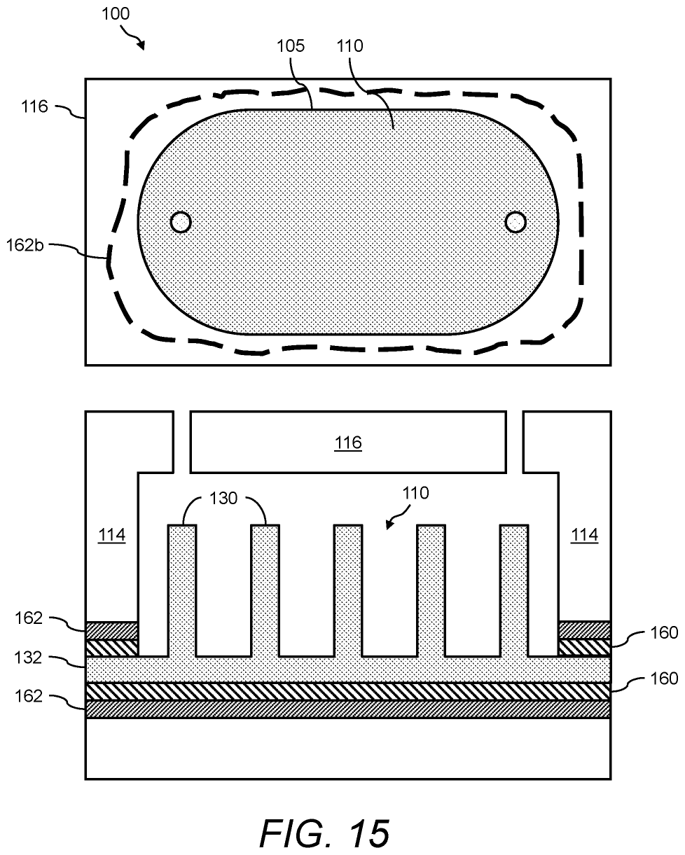

Referring now to FIG. 13, FIG. 14, and FIG. 15 are side views of examples of utilizing chemical bonding processes for forming modular active surface devices 100, which is still another example of an adhesive-free assembly process. For example, certain chemical bonding processes may be used to bond micropost substrate 132 of micropost active surface layer 110 (e.g., PDMS material) to active surface substrate 112 and/or mask layer 114 (e.g., thermoplastic material). Two different chemical groups that fit together lock and key or form a covalent bond may be used to form a substantially permanent bond.

For example, micropost substrate 132 (e.g., PDMS substrate) of micropost active surface layer 110 may receive one type of chemical treatment, while active surface substrate 112 and/or mask layer 114 (e.g., thermoplastic material) may receive a different type of chemical treatment. In one example, micropost substrate 132 of micropost active surface layer 110 may receive a (3-Aminopropyl) triethoxysilane (APTES) treatment process of the PDMS material. APTES can be used to generate amine groups on the PDMS that can be used to covalently bond to, for example, epoxy groups on thermoplastics. Accordingly, active surface substrate 112 may be treated with epoxy groups. The epoxy groups may be generated, for example, using silane coatings, 3-(glycidoxypropyl) triethoxysilane (GOPTES), or glues.

Accordingly, a type A chemical treatment layer 160 may be formed on micropost substrate 132 (e.g., PDMS substrate) of micropost active surface layer 110. The type A chemical treatment layer 160 may be the result of the APTES treatment process. A type B chemical treatment layer 162 may be formed on active surface substrate 112 (e.g., thermoplastic material). The type B chemical treatment layer 162 may be the result of treatment with epoxy groups. When type A chemical treatment layer 160 and type B chemical treatment layer 162 are brought together, a chemical bond occurs between the two layers. FIG. 13 shows the type A chemical treatment layer 160 on the lower surface of micropost substrate 132 and the type B chemical treatment layer 162 on the upper surface of active surface substrate 112. In this way, micropost substrate 132 of micropost active surface layer 110 may be chemically bonded to active surface substrate 112. The application of type A chemical treatment layer 160 and type B chemical treatment layer 162 shown in FIG. 13 is an example of chemical treatments that do not interfere with processes occurring in reaction chamber 105.

These chemical treatments may be performed in liquid phase or vapor phase. For example, for the type A chemical treatment layer 160, the APTES treatment may be performed in liquid phase or vapor phase. For the type B chemical treatment layer 162, epoxy may be applied in liquid phase, like a glue coating, on active surface substrate 112, or a silane coating may be applied in vapor phase. While vapor phase processes may be more complex than liquid phase processes, vapor phase processes may have the advantage of not being limited to specific geometries. Further, vapor phase processes do not require highly planar surfaces, although a planar surface does lend to a strong bond.

While FIG. 13 shows a process of chemically bonding the non-reaction chamber-side of micropost active surface layer 110, it may be possible to also use chemical bonding on the reaction chamber-side of micropost active surface layer 110. For example, FIG. 14 shows that both the lower and upper surfaces of micropost substrate 132 of micropost active surface layer 110 may receive, for example, the APTES treatment process. Accordingly, both the lower and upper surfaces of micropost substrate 132 have a type A chemical treatment layer 160. Further, both the upper surface of active surface substrate 112 and the lower surface of mask layer 114 may be, for example, treated with epoxy groups. Accordingly, both the upper surface of active surface substrate 112 and the lower surface of mask layer 114 have a type B chemical treatment layer 162.

In one example, to avoid interference with processes occurring in reaction chamber 105, the reaction chamber 105 region of the upper surface of micropost substrate 132 of micropost active surface layer 110 may be masked during the APTES treatment process to selectively form the type A chemical treatment layer 160. In another example, to avoid interference with processes occurring in reaction chamber 105, the APTES treatment process may include selectively dotting or inking the type B chemical treatment layer 162 around reaction chamber 105 as shown in FIG. 15. However, in another example, the APTES treatment process may occur fully across the upper surface of micropost active surface layer 110, including across the array of microposts 130 in reaction chamber 105. This may be possible because the APTES treatment left in reaction chamber 105 may degrade over time and cause substantially no problems later at run time.

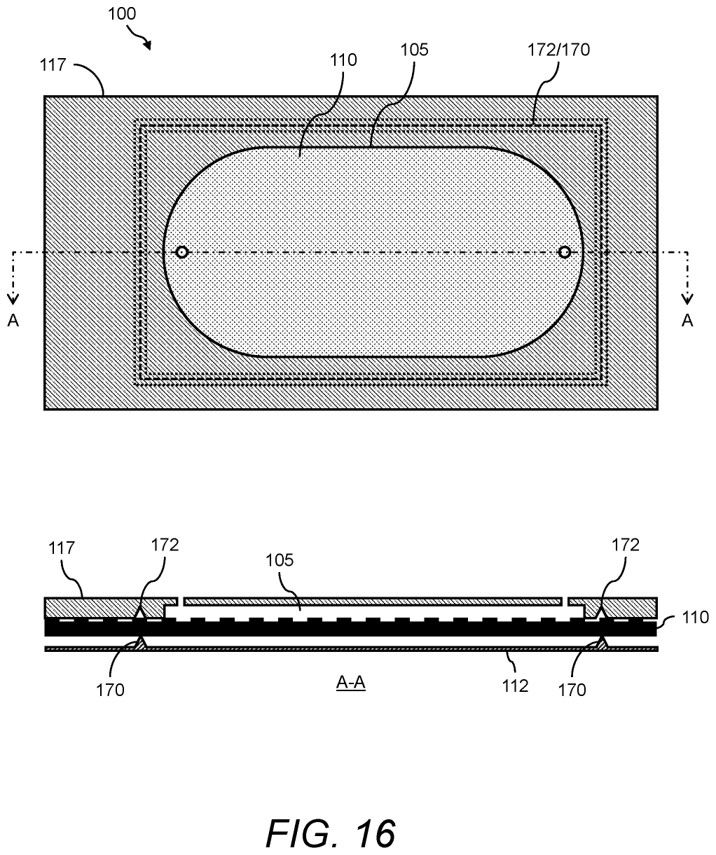

Referring now to FIG. 16 is a top view and a side view of an example of a modular active surface device 100 including an adhesive-free chamber sealing process. In this example, a substantially continuous pointed ridge feature 170 is provided with an active surface substrate 112 and around the perimeter of reaction chamber 105. Pointed ridge feature 170 protrudes, for example, from the upper surface of active surface substrate 112 and toward micropost active surface layer 110. An opposing v-groove feature 172 is provided, for example, on the lower surface of substrate 117. The location, size, and shape of v-groove feature 172 substantially corresponds to the location, size, and shape of pointed ridge feature 170.

In operation, when active surface substrate 112, micropost active surface layer 110, and substrate 117 are squeezed or compressed together, pointed ridge feature 170 of active surface substrate 112 is fitted in v-groove feature 172 of substrate 117. In doing so, micropost active surface layer 110 (e.g., PSMS layer) is squeezed or pinched between pointed ridge feature 170 and v-groove feature 172 to form a seal. In one example, this arrangement of modular active surface device 100 may be held in compression via an arrangement of integrated clamp mechanisms 140 described with reference to FIG. 9, FIG. 10, and FIG. 11.

Referring now again to FIG. 1 through FIG. 16, in one example, any of the modular active surface devices 100 including those using adhesive-free processes may be formed or fabricated individually. However, in another example, the modular active surface devices 100 shown and described in FIG. 1 through FIG. 16 and including those using adhesive-free processes may be mass produced using large-scale manufacturing processes. For example, modular active surface devices 100 may be formed using the large-scale manufacturing processes shown and described with reference to U.S. Patent Pub. No. 20200254454, entitled “Modular Active Surface Devices for Microfluidic Systems and Methods of Making Same,” published on Aug. 13, 2020; the entire disclosure of which is incorporated herein by reference. The U.S. Patent Pub. No. 20200254454 describes a large-scale manufacturing method of mass-producing modular active surface devices.

Although the foregoing subject matter has been described in some detail by way of illustration and example for purposes of clarity of understanding, it will be understood by those skilled in the art that certain changes and modifications can be practiced within the scope of the appended claims.

1. A modular active surface device comprising:
(a) the following layers:
(i) a bottom substrate comprising an active surface layer;
(ii) a mask layer on the active surface layer comprising an opening establishing a reaction chamber; and
(iii) a top substrate on the mask layer enclosing the reaction chamber, wherein the top substrate comprises a reagent hopper enclosed therein;
(b) a first port in the top substrate providing a fluid path from the reagent hopper into the reaction chamber; and
(c) a second port in the bottom substrate, the top substrate, or the mask layer providing a fluid path out of the reaction chamber.

2. The modular active surface device of claim 1, wherein the top substrate on the mask layer comprises two or more reagent hoppers oriented out-of-plane of the reaction chamber.

3. The modular active surface device according to claim 1, wherein one or more reagent hoppers each hold a quantity of a dried reagent.

4. The modular active surface device of claim 3, wherein the dried reagent is selected from a group consisting of a pellet, a cake, a block, a brick, a sphere, or beads of a dried reagent.

5. The modular active surface device according to claim 2, wherein one or more reagent hoppers each hold a quantity of a rehydrated dried reagent.

6. The modular active surface device according to claim 1, wherein the active surface layer comprises actuatable microposts attached to the surface of the active surface layer, wherein the actuatable microposts extend into the reaction chamber.

7. The modular active surface device of claim 6, wherein the actuatable microposts attached to the surface of the active surface layer are configured for actuation in the presence of an actuation force.

8. The modular active surface device of claim 7, wherein the actuation force is selected from a group consisting of a magnetic field, a thermal field, a sonic field, an optical field, an electrical field, and a vibrational field.

9. The modular active surface device according to claim 6, wherein the active surface layer in the reaction chamber is configured for mixing operations, binding operations, and cell processing operations.

10. The modular active surface device according to claim 1, further comprising an integrated clamping mechanism compressing the layers of the modular active surface device together.

11. The modular active surface device according to claim 1, further comprising:
(a) an active surface substrate comprising an actuatable micropost active surface layer and a continuous or a substantially continuous pointed ridge feature provided around the perimeter of a reaction chamber, wherein the pointed ridge feature protrudes from an upper surface of the active surface substrate and toward the actuatable micropost active surface layer;
(b) an opposing V-shaped groove feature provided on an inner surface of a microfluidics cartridge substrate, wherein the location, size, and shape of the opposing V-shaped groove feature substantially corresponds to the location, size, and shape of the pointed ridge feature;
(c) a means for applying a compression force to the pointed ridge feature;
wherein, the means for applying a compression force is arranged relative to the pointed ridge feature such that application of a compression force causes the pointed ridge feature to engagedly fit into the opposing V-shaped groove feature of the microfluidics cartridge substrate, thereby forming a seal.

12. The modular active surface device of claim 2, wherein each reagent hopper contains a reagent selected from a group consisting of a rehydratable dried reagent, a liquid reagent, or a releasable reagent.

13. The modular active surface device of claim 12, wherein the reagent hoppers contain the same reagent or a different reagent.

14. The modular active surface device of claim 1, wherein (i) the top substrate comprises a mask layer enclosing the reaction chamber and (ii) the first port in the top substrate comprises a fluid path from the top substrate into the reaction chamber.
